(19) United States
(12) Patent Application Publication
(10) Pub. No.: US 2015/0213923 A1
(43) Pub. Date: Jul. 30, 2015

(54) ELECTRONIC APPARATUS, EXPOSING DEVICE, AND IMAGE FORMING APPARATUS

(71) Applicant: FUJI XEROX CO., LTD., Tokyo (JP)

(72) Inventor: Kazuhiro YOSHINO, Kanagawa (JP)

(21) Appl. No.: 14/490,278

(22) Filed: Sep. 18, 2014

(30) Foreign Application Priority Data
Jan. 29, 2014 (JP) 2014-014113

(51) Int. Cl. H01B 7/08; G03G 15/00

(52) U.S. Cl. CPC H01B 7/0869; G03G 15/80

(57) ABSTRACT

Provided is an electronic apparatus including a housing formed of a conductor, a first cable that includes a first shielding layer, a conductive wire group arranged on one surface of the first shielding layer, and a first insulating layer that covers the conductive wire group, and is disposed to cause the first insulating layer to come into contact with the housing, and a second cable that includes a second shielding layer, a conductive wire group arranged on one surface of the second shielding layer, and a second insulating layer that covers the conductive wire group, and is stacked on the first cable to cause the second insulating layer to come into contact with the first shielding layer.

### CROSS-REFERENCE TO RELATED APPLICATIONS

This application is based on and claims priority under 35 USC 119 from Japanese Patent Application No. 2014-014113 filed Jan. 29, 2014.

### BACKGROUND

### Technical Field

The present invention relates to an electronic apparatus, an exposing device, and an image forming apparatus.

### SUMMARY

According to an aspect of the invention, there is provided an electronic apparatus including:

a housing formed of a conductor;

a first cable that includes a first shielding layer, a conductive wire group arranged on one surface of the first shielding layer, and a first insulating layer that covers the conductive wire group, and is disposed to cause the first insulating layer to come into contact with the housing; and

a second cable that includes a second shielding layer, a conductive wire group arranged on one surface of the second shielding layer, and a second insulating layer that covers the conductive wire group, and is stacked on the first cable to cause the second insulating layer to come into contact with the first shielding layer.

### BRIEF DESCRIPTION OF THE DRAWINGS

Exemplary embodiments of the present invention will be described in detail based on the following figures, wherein:

FIG. 1 is a view illustrating the overall configuration of an image forming apparatus;

FIG. 2 is a view illustrating the external forms of exposing units;

FIG. 3 is a perspective view illustrating an end portion of a flexible flat cable (FFC);

FIG. 4 is a cross-sectional view of the end portion of the FFC;

FIG. 5 is a view illustrating a wiring state of the FFC;

FIG. 6 is a view illustrating a state where the FFCs are stacked; and

FIG. 7 is a perspective view illustrating a wiring state of an FFC according to a modification example.

### DETAILED DESCRIPTION

### 1. Exemplary Embodiment

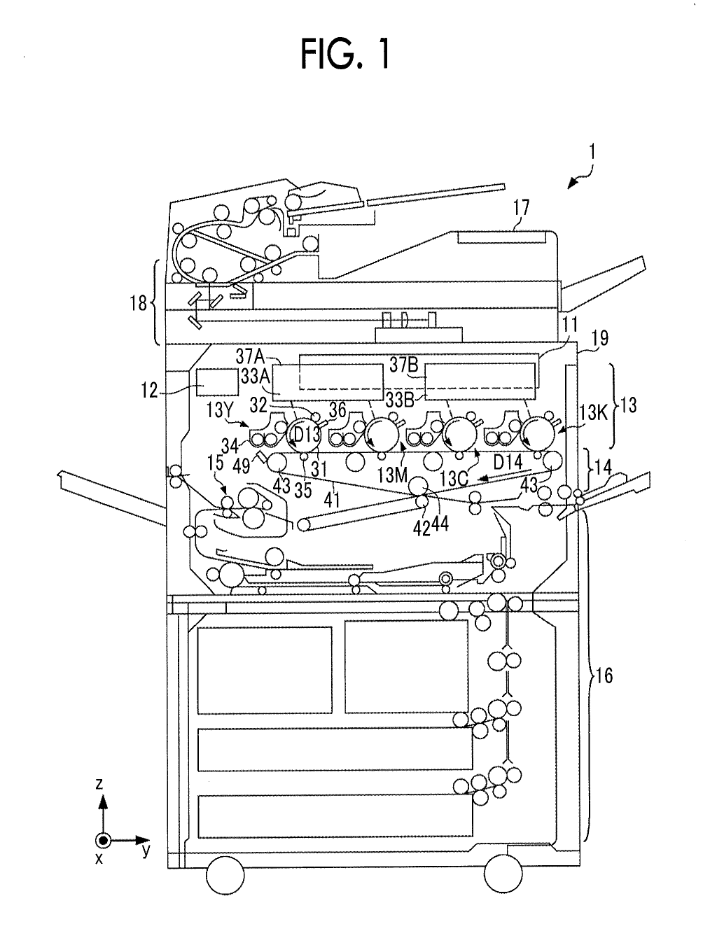

FIG. 1 is a view illustrating the overall configuration of an image forming apparatus 1 according to an exemplary embodiment of the invention. The image forming apparatus 1 is an apparatus for forming an image in an electrophotographic method. The image forming apparatus 1 according to this exemplary embodiment forms an image on a sheet that is an example of a medium, on the basis of image data representing the image. The image forming apparatus 1 according to this exemplary embodiment is of a so-called tandem type. Hereinafter, in the drawings, in order to describe the arrangement of each configuration of the image forming apparatus 1, a three-dimensional orthogonal coordinate system (xyz right hand rule) is used. In the coordinate symbols illustrated in the drawings, a symbol of a black dot in a circle having a white inside denotes a direction to the forward side from the inner side of the drawings.

A control unit 11 includes a central processing unit (CPU), a read only memory (ROM), and a random access memory (RAM). The CPU controls each unit of the image forming apparatus 1 by reading and executing computer programs (hereinafter, simply referred to as programs) stored in the ROM or a storage unit 12. The storage unit 12 is a non-volatile storage unit such as a hard disk drive and stores the programs. An operating unit 17 includes operation buttons and the like to input various instructions and receives an operation by a user to supply a signal corresponding to the operation contents to the control unit 11. An image reading unit 18 optically reads the image formed on the medium and generates image data representing the read image. A housing 19 is formed of a conductor such as sheet metal.

Developing units 13Y, 13M, 13C, and 13K form toner images on the sheet. The characters Y, M, C, and K respectively mean the configurations corresponding to yellow, magenta, cyan, and black toners. The developing units 13Y, 13M, 13C, and 13K use different toners but are not remarkably different in the configurations. Hereinafter, the developing units 13Y, 13M, 13C, and 13K are collectively called a “developing unit 13” when they are not necessarily distinguished from each other, by omitting the characters representing the toner colors.

Each developing unit 13 includes a photosensitive drum 31 (an example of an image holding member), a charging unit 32, a developer unit 34 (an example of a developing unit), a primary image transfer roller 35, and a drum cleaner 36. The photosensitive drum 31 is an image holding member having a charge generating layer and a charge transporting layer and is rotated by a driving unit (not illustrated) in an arrow D13 direction in the figure. The charging unit 32 charges the surface of the photosensitive drum 31.

Each of exposing units 33A and 33B (an example of an exposing unit) includes a laser emitting source, a polygon mirror (both are not illustrated), and the like. The exposing unit 33A emits a laser light according to the image data toward the photosensitive drums 31Y and 31M after being charged by the charging units 32Y and 32M, under the control of the control unit 11. The exposing unit 33B emits a laser light according to the image data toward the photosensitive drums 31C and 31K after being charged by the charging units 32C and 32K, under the control of the control unit 11. Accordingly, a latent image is held by each photosensitive drum 31. The image data may also be acquired from an external device via the image reading unit 18 or a communicating unit (not illustrated) by the control unit 11. The external device is, for example, a storage device that stores data representing an image.

Respective housings 37A and 37B of the exposing units 33A and 33B are formed of conductors such as sheet metal. The housings 37A and 37B are fixed to the housing 19 of the image forming apparatus 1 and are held so that the distance from the outer circumferential surface of the photosensitive drum 31 is a predetermined distance. In addition, in the following description, the exposing units 33A and 33B are collectively called an “exposing unit 33” when they are not necessarily distinguished from each other. In addition, the housings 37A and 37B are collectively called a “housing 37” when they are not necessarily distinguished from each other.

The developer unit 34 contains a two-component developer including toner of any of colors Y, M, C, and K and a magnetic carrier such as ferrite powder. In addition, as the bristle tip of the magnetic brush formed on the developer unit 34 comes into contact with the surface of the photosensitive drum 31, the toner adheres to a part exposed by the exposing unit 33, that is, a streak of the electrostatic latent image, on the surface of the photosensitive drum 31, thereby forming (developing) the image on the photosensitive drum 31.

The primary image transfer roller 35 generates a predetermined potential difference at a position where an intermediate image transfer belt 41 of a transfer unit 14 opposes the photosensitive drum 31, and the image is transferred onto the intermediate image transfer belt 41 by the potential difference. The drum cleaner 36 removes toner that is not transferred and remains on the surface of the photosensitive drum 31 after transferring the image and removes charges on the surface of the photosensitive drum 31. That is, the drum cleaner 36 removes unnecessary toner or charges from the photosensitive drum 31 for a subsequent image forming process.

The transfer unit 14 (an example of a transfer unit) is a transfer unit that includes the intermediate image transfer belt 41, a secondary image transfer roller 42, a belt transporting roller 43, and a backup roller 44, and transfers the image formed by the developing unit 13 onto a sheet of a paper type determined by the operation of the user. The intermediate image transfer belt 41 is a belt member with no ends and the intermediate image transfer belt 41 is tensioned by the belt transporting roller 43 and the backup roller 44. At least one of the belt transporting roller 43 and the backup roller 44 includes a driving unit (not illustrated) to move the intermediate image transfer belt 41 in an arrow D14 direction in the figure. In addition, the belt transporting roller 43 or the backup roller 44 which does not include a driving unit is rotated by following the movement of the intermediate image transfer belt 41. As the intermediate image transfer belt 41 moves and rotates in the arrow D14 direction in the figure, the image on the intermediate image transfer belt 41 is moved to a region nipped between the secondary image transfer roller 42 and the backup roller 44.

The secondary image transfer roller 42 transfers the image on the intermediate image transfer belt 41 onto the sheet transported from a transporting unit 16, using the potential difference from the intermediate image transfer belt 41. A belt cleaner 49 removes toner that is not transferred and remains on the surface of the intermediate image transfer belt 41. In addition, the transfer unit 14 or the transporting unit 16 transports the sheet (an example of a medium on which an unfixed image is formed) having the image transferred thereon to a fixing unit 15. The fixing unit 15 fixes the image transferred onto the sheet through heating. The transporting unit 16 includes containers and feed rollers. The containers accommodate sheets as media, which are cut to predetermined sizes. The sheets accommodated in each of the containers are taken out by the feed rollers one by one by the instruction of the control unit 11 and are transported to the transfer unit 14 via a sheet path. In addition, the medium is not limited to the sheet, and for example, may be a sheet made of a resin. In short, the medium may be a material on which an image may be formed on the surface.

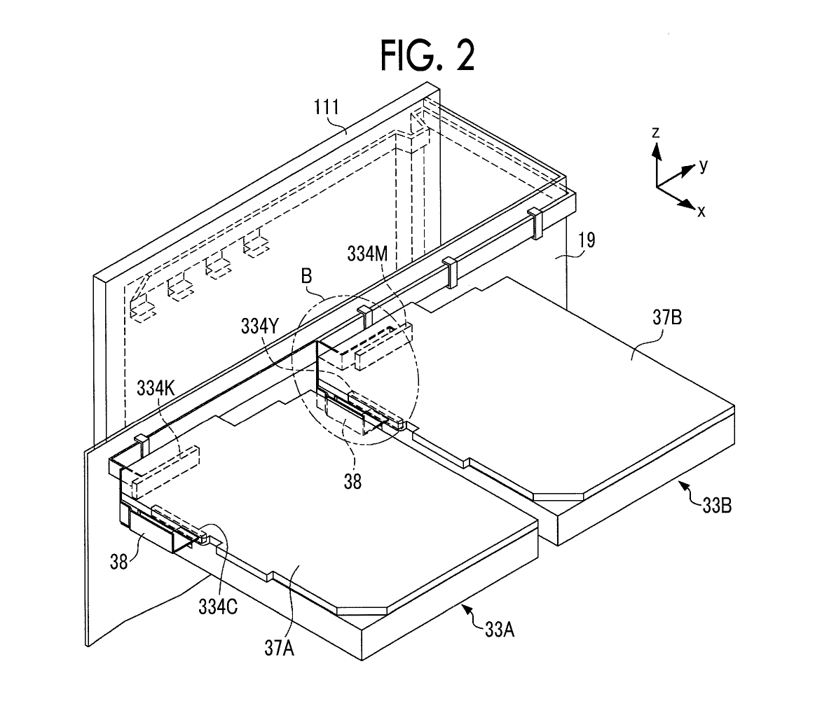

FIG. 2 is a perspective view illustrating the external forms of the exposing units 33A and 33B. As illustrated in FIG. 2, a driving substrate 111 of the control unit 11 is provided at a position on the negative direction side of the x axis when viewed from the exposing units 33A and 33B. The exposing units 33A and 33B are electrically connected to the driving substrate 111 of the control unit 11 by flexible flat cables (hereinafter, “FFC”) 38. Each of the FFCs 38 (examples of a first cable and a second cable) is an electrical connection member of which one end is electrically connected to a laser control substrate 334Y or 334M of the exposing unit 33A or to a laser control substrate 334C or 334K of the exposing unit 33B and the other end is electrically connected to the driving substrate 111 of the control unit 11 and which enables power supply to the exposing units 33A and 33B and transmission of electrical signals. An apparatus including the housings 37 and 19 and the FFCs 38 is an example of an electronic apparatus according to the exemplary embodiment of the invention. In addition, a device including the exposing unit 33, the housings 37 and 19, and the FFCs 38 is an example of an exposing device according to the exemplary embodiment of the invention.

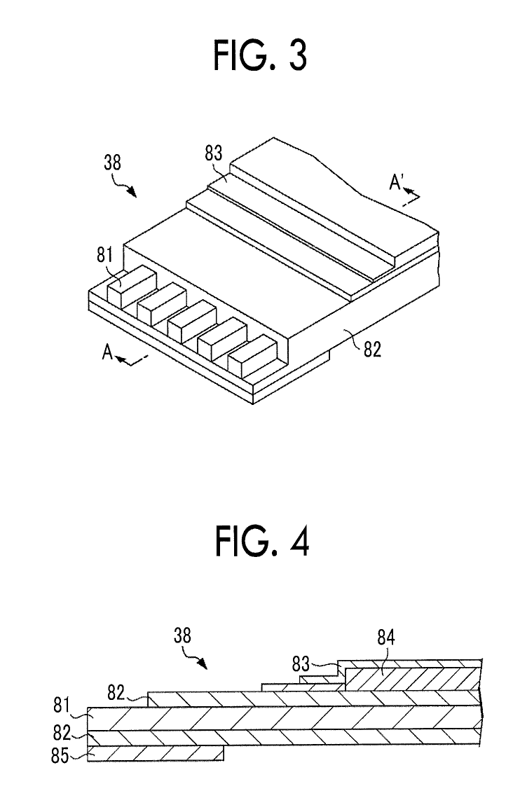

FIG. 3 is a view illustrating the external form of an end portion of the FFC 38, and FIG. 4 is a cross-sectional view taken along line A-A′ of the end portion of the FFC 38 illustrated in FIG. 3. The FFC 38 has a configuration in which conductors (conductive wires) 81, 81, . . . arranged at intervals are interposed between flexible band-like insulating materials 82. The conductors 81, 81, . . . supply power or transmit electrical signals through electrical conduction. That is, the conductor 81 functions as a power supply wire or a signal wire. The insulating material 82 is a member for preventing a short circuit of the conductors 81. As an example, the conductor 81 is a tin coated copper foil, and the insulating material 82 is a polyester tape. In addition, to one surface of the FFC 38, a shield member 83 (examples of a first shielding layer and a second shielding layer) is adhered. The shield member 83 is a member for preventing leakage of signals from the power supply wire or the signal wire, and for preventing infiltration of noise into the power supply wire or the signal wire from the outside, and is formed of a material having an electromagnetic wave shielding effect (metal film or metal mesh, for example, copper is used as the metal). The shield member 83 is not provided on the rear surface of the FFC 38. That is, the FFC 38 includes the shield member 83, the conductors 81, 81, . . . (conductive wire group) arranged on one surface of the shield member 83, and the insulating materials 82 (examples of a first insulating layer and a second insulating layer) that cover the conductors 81, 81, . . . . In the following description, for convenience of description, the surface of the FFC 38 on which the shield member 83 is provided is referred to as a “shielded surface”, and the surface on which the shield member 83 is not provided is referred to as an “unshielded surface”.

As illustrated in FIG. 4, the shield member 83 further includes an intermediate member 84. The intermediate member 84 is provided at a position interposed between the insulating material 82 and the shield member 83 (that is, a position interposed between the conductor 81 and the shield member 83). The intermediate member 84 is a member for adjusting the impedance of the FFC 38, and is formed of, for example, a polyolefin resin. The impedance of the FFC 38 is determined by the distance between the conductor 81 and the shield member 83, and the impedance increases as the distance between the conductor 81 and the shield member 83 increases. The impedance is adjusted by providing an interval between the conductor 81 and the shield member 83 by inputting the intermediate member 84 between the conductor 81 and the shield member 83. A reinforcing plate 85 is a member for reinforcing the end portion of the FFC 38, and for example, a PET (polyethylene terephthalate) resin film.

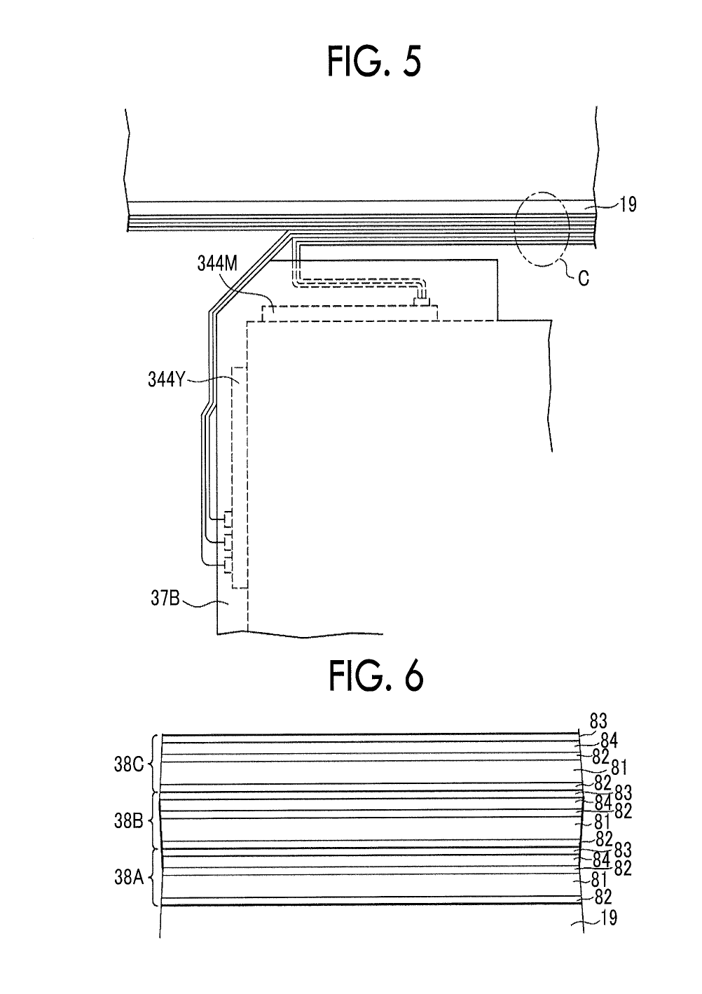

FIG. 5 is a view schematically illustrating a case where a wiring state in the vicinity of a B part of the FFC 38 illustrated in FIG. 2 is viewed in the positive direction of the z axis. In FIG. 5, for ease of understanding of the invention, the thickness of the FFC 38 is illustrated to be larger than in practice. As illustrated in FIGS. 2 and 5, one ends of the FFCs 38 are respectively connected to the laser control substrates 334Y, 334M, 334C, and 334K of the exposing unit 33 so that the FFCs 38 are drawn around along the side surfaces of the housings 37A, 37B, and 19, and the other ends thereof are connected to the driving substrate 111 of the control unit 11. At this time, the FFCs 38 are stacked and drawn around as illustrated. In this exemplary embodiment, two FFCs 38 are used for each of the colors Y, M, C, and K such that a total of eight FFCs 38 are drawn around while being bound and overlapped. In addition, the FFCs 38 may be overlapped and adhered to each other.

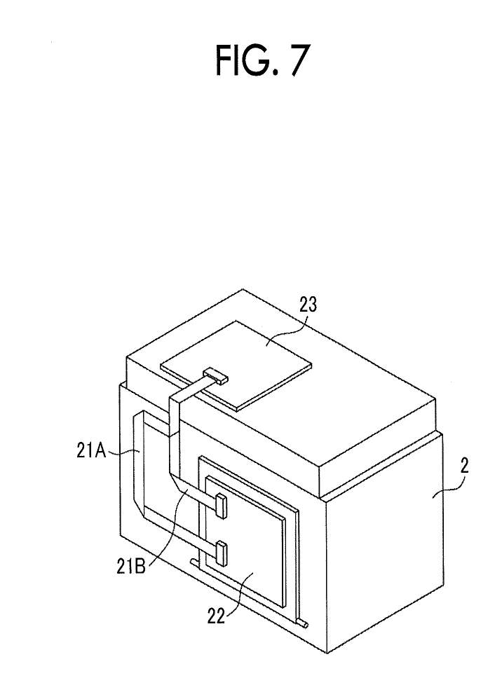

FIG. 6 is a view illustrating a state where the FFCs 38 are stacked (C part of FIG. 5). In the example illustrated in FIG. 6, for ease of understanding of the invention, a state where three FFCs 38A, 38B, and 38C are stacked on the surface of the housing 19 is illustrated. However, in practice, eight FFCs 38 are stacked on the surface of the housing 19. In the example illustrated in FIG. 6, the FFC 38A is installed so that the unshielded surface of the FFC 38A comes into contact with the surface of the housing 19, and thereon, the FFC 38B is overlapped so that the unshielded surface thereof comes into contact with the FFC 38A (that is, the shielded surface of the FFC 38A). In addition, on the FFC 38B, the FFC 38C is overlapped so that the unshielded surface thereof comes into contact with the FFC 38B (that is, the shielded surface of the FFC 38B). That is, in this exemplary embodiment, the FFCs 38 are stacked so that the unshielded surfaces thereof come into contact with the shielded surfaces of the other FFCs 38 or the housing 37 or 19.

As illustrated in FIG. 2, most parts of the eight FFCs 38 are stacked, and the eight FFCs 38 are drawn around while coming into contact with the housing 37A, 37B, or 19. However, in a connection part between the FFC 38 and the laser control substrate 334 or in a connection part between the FFC 38 and the driving substrate 111, the FFCs 38 may not be stacked or do not come into contact with the housing 37 or 19. In this exemplary embodiment, a part of the half or more of each of the FFCs 38 in the longitudinal direction comes into contact with the shielded surface of another FFC 38 or the housing 37 or 19.

Next, the impedance of the FFC 38 according to this exemplary embodiment will be described. In this exemplary embodiment, the thickness of the intermediate member 84 of the FFC 38 is adjusted so that the impedance is in a range of a target value (a predetermined range) when the FFCs 38 are stacked. In other words, the thickness of the intermediate member 84 of the FFC 38 is adjusted so that the impedance in a case where a single flexible flat cable is used as a single member is in a range higher than the range of the target value (predetermined range).

This is because the impedance in a case where the FFCs 38 according to this exemplary embodiment are stacked and grounded to the housing in use is lower than that in a case where a single FFC 38 is used as a single member. Specifically, for example, in a case where the impedance of the FFC 38 in the case where a single FFC 38 is used as a single member is from about 61.3 to about 66.3Ω, the impedance when two or more FFCs 38 are stacked and grounded to the housing in use decreases to from about 59.7 to about 60.3Ω. Therefore, in this exemplary embodiment, the thickness of the intermediate member 84 is set to allow the impedance of each of the FFCs 38 as the single member to be higher than a design target value so that the impedance in the case where the FFCs 38 are stacked and grounded to the housing in use becomes the design target value.

However, when FFCs are overlapped, there may be cases where electromagnetic noise may be generated from the overlapped FFCs. As a countermeasure, for example, providing an electromagnetic wave shield member on both of the front surface and the rear surface of the FFC is considered. However, in the configuration in which the electromagnetic wave shield member is provided on both surfaces, the thickness of the ETC increases, and there may be cases where the FFC is not easily drawn around. For this, in this exemplary embodiment, the electromagnetic wave shield member is not provided on one surface of the FFC 38. Accordingly, in a case where the FFCs 38 are stacked, the thickness of the FFCs 38 is smaller than that in the case where the electromagnetic wave shield member is provided on both surfaces. In addition, the FFCs 38 are stacked in use so that the unshielded surface comes into contact with the shielded surface of another FFC 38, thereby obtaining a shield effect corresponding to the case where the electromagnetic wave shield member is provided on both surfaces.

### 2. Modification Example

While the exemplary embodiment of the invention has been described, the invention is not limited to the above-described exemplary embodiment and may be modified in various forms. Examples thereof will be described. In addition, the following forms may be combined.

(1) In the above-described exemplary embodiment, the configuration is described in which the laser control substrate 334 of the exposing unit 33 is electrically connected to the driving substrate 111 of the control unit 11 by the FFC 38. However, components connected by the FFC 38 are not limited to those in the above-described exemplary embodiment. For example, as an image reading device that reads an image, the FFC according to the exemplary embodiment may be used. FIG. 7 is a view illustrating a case where the FFC according to the exemplary embodiment is used in an image reading device 2. In the figure, FFCs 21A and 21B electrically connect a control substrate 22 to a control substrate 23 for image reading. The configurations of the FFCs 21A and 21B correspond to the configuration of the FFC 38 described above in the exemplary embodiment. Even in the example illustrated in FIG. 7, the FFCs 21A and 21B having the electromagnetic wave shield member provided on one surface are stacked in use.

In the above-described exemplary embodiment, the exposing unit 33 which includes the laser light source and the polygon mirror and performs exposure in a laser raster output scanner (ROS) method is used. However, the invention is not limited thereto, and an exposing unit which performs exposure in an LED print head method using an LED (light-emitting diode) as a light source may be used.

(2) The image forming apparatus including the fixing unit 15 is not limited to the tandem type of the above-described exemplary embodiment, and may have another configuration such as a rotary type. In addition, the image forming apparatus including the fixing unit 15 is not limited to an image forming apparatus which forms an image by overlapping toner images of plural colors and may also be an image forming apparatus which forms a toner image of a single color.

In addition, in the above-described exemplary embodiment, the FFC 38 which is a flexible flat cable is exemplified. However, the shape of the flexible cable is not limited to a flat shape. The shape of the flexible cable may be another shape, for example, an uneven shape.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic apparatus comprising:
a housing formed of a conductor;
a first cable that includes a first shielding layer, a conductive wire group arranged on one surface of the first shielding layer, and a first insulating layer that covers the conductive wire group, and is disposed to cause the first insulating layer to come into contact with the housing; and
a second cable that includes a second shielding layer, a conductive wire group arranged on one surface of the second shielding layer, and a second insulating layer that covers the conductive wire group, and is stacked on the first cable to cause the second insulating layer to come into contact with the first shielding layer.

2. The electronic apparatus according to claim 1, wherein
each of the first cable and the second cable includes an intermediate member that adjusts an impedance, at a position interposed between the conductive wire group and the shielding layer, and
the intermediate member has a thickness at which the impedance in a case where the first cable and the second cable are stacked is in a predetermined range.

3. The electronic apparatus according to claim 1,
wherein a part of half or more of the first cable in a longitudinal direction of the first cable comes into contact with the housing.

4. The electronic apparatus according to claim 2,
wherein a part of half or more of the first cable in a longitudinal direction of the first cable comes into contact with the housing.

5. An exposing device comprising:
an exposing unit that exposes an exposure target body;
a housing formed of a conductor;
a first cable that includes a first shielding layer, a conductive wire group arranged on one surface of the first shielding layer, and a first insulating layer that covers the conductive wire group, and is disposed to cause the first insulating layer to come into contact with the housing; and
a second cable that includes a second shielding layer, a conductive wire group arranged on one surface of the second shielding layer, and a second insulating layer that covers the conductive wire group, and is stacked on the first cable to cause the second insulating layer to come into contact with the first shielding layer.

6. An image forming apparatus comprising:
the exposing device according to claim 5, that forms a latent image by exposing an image holding member;
a developing unit that forms a toner image by developing the latent image formed on a surface of the image holding member; and
a transfer unit that transfers the toner image onto a recording medium.
